(19) United States
(12) Patent Application Publication
(10) Pub. No.: US 2017/0300742 A1
(43) Pub. Date: Oct. 19, 2017

(54) SYSTEMS AND METHODS FOR RECOGNIZING AN OBJECT IN AN IMAGE

(71) Applicant: QUALCOMM Incorporated, San Diego, CA (US)

(72) Inventors: Jian Wei, San Diego, CA (US); Ashwath Aithal, San Diego, CA (US); Vasudev Bhaskaran, San Diego, CA (US)

(21) Appl. No.: 15/098,979

(22) Filed: Apr. 14, 2016

(51) Int. Cl. G06K 9/00

(52) U.S. Cl. CPC G06K 9/00288; G06K 9/00228; G06K 9/00758

(57) ABSTRACT

An electronic device is described. The electronic device includes a memory configured to store a composite search space comprising a plurality of adjacent cells. Each of the adjacent cells includes a representation of an object. The electronic device also includes a dedicated engine configured to match a representation of an object from a captured image with the representations of the objects in the composite search space.

### FIELD OF DISCLOSURE

The present disclosure relates generally to electronic devices. More specifically, the present disclosure relates to systems and methods for recognizing an object in an image.

### BACKGROUND

Some electronic devices (e.g., cameras, video camcorders, digital cameras, cellular phones, smart phones, computers, televisions, automobiles, personal cameras, action cameras, surveillance cameras, mounted cameras, connected cameras, robots, drones, smart applications, healthcare equipment, set-top boxes, etc.) capture and/or utilize images. For example, a smartphone may capture and/or process still and/or video images. Processing images may demand a relatively large amount of time, processing, memory and energy resources. The resources demanded may vary in accordance with the complexity of the processing.

Identifying an object in an image may require a large amount of resources. For example, it may be difficult to efficiently identify an object in an image. This may even make object identification impractical on some platforms. As can be observed from this discussion, systems and methods that improve image processing may be beneficial.

### SUMMARY

An electronic device is described. The electronic device includes a memory configured to store a composite search space comprising a plurality of adjacent cells. Each of the adjacent cells includes a representation of an object. The electronic device also includes a dedicated engine configured to match a representation of an object from a captured image with the representations of the objects in the composite search space.

The dedicated engine may be a motion search engine. The electronic device may include dedicated video encoder hardware that includes the dedicated engine. The dedicated engine may be configured to calculate a sum of absolute differences (SADs) for each of a plurality of feature sets in the composite search space. The composite search space may include sets of feature sets.

Each of the representations of the composite search space may include a patch of an image. Each of the representations of the composite search space may include a feature set. The feature sets may be arranged to fit macroblock boundaries with a motion search engine.

The electronic device may include a processor configured to obtain a plurality of images and to determine a set of patches for each of the plurality of images. The processor may be configured to determine a feature set for each of the patches and to produce the composite search space based on the feature sets. The electronic device may include a camera configured to obtain the captured image.

A method performed by an electronic device is also described. The method includes obtaining a composite search space comprising a plurality of adjacent cells. Each of the adjacent cells includes a representation of an object. The method also includes matching, by a dedicated engine, a representation of an object from a captured image with the representations of the objects in the composite search space.

An apparatus is also described. The apparatus includes means for obtaining a composite search space comprising a plurality of adjacent cells. Each of the adjacent cells includes a representation of an object. The apparatus also includes dedicated engine means for matching a representation of an object from a captured image with the representations of the objects in the composite search space.

A computer-program product is also described. The computer-program product includes a non-transitory computer-readable medium with instructions. The instructions include code for causing an electronic device to obtain a composite search space comprising a plurality of adjacent cells. Each of the adjacent cells includes a representation of an object. The instructions also include code for causing the electronic device to match, by a dedicated engine, a representation of an object from a captured image with the representations of the objects in the composite search space.

### BRIEF DESCRIPTION OF THE DRAWINGS

FIG. 1 is a block diagram illustrating one example of an electronic device in which systems and methods for recognizing an object in an image may be implemented;

FIG. 2 is a flow diagram illustrating one configuration of a method for recognizing an object in an image;

FIG. 3 is a flow diagram illustrating one configuration of a method for generating a composite search space;

FIG. 4 is a diagram illustrating one example of generating a composite search space;

FIG. 5 is a diagram illustrating another example of generating a composite search space;

FIG. 6 is a diagram illustrating another example of generating a composite search space;

FIG. 7 is a block diagram illustrating a more specific example of an electronic device in which systems and methods for recognizing an object in an image may be implemented;

FIG. 8 is a flow diagram illustrating a more specific configuration of a method for recognizing an object in an image;

FIG. 9 is a diagram illustrating one example of operations that may be performed for recognizing an object in an image in accordance with the systems and methods disclosed herein;

FIG. 10 illustrates certain components that may be included within an electronic device configured to implement various configurations of the systems and methods disclosed herein;

FIG. 11 illustrates examples of electronic devices in which systems and methods for recognizing an object in an image may be implemented;

FIG. 12 is a functional block diagram illustrating an example of recognizing an object in an image in accordance with some configurations of the systems and methods disclosed herein;

FIG. 13 is a diagram illustrating an example of an approach for feature extraction;

FIG. 14 is a diagram illustrating examples of a query feature set and a search space feature set; and

FIG. 15 is a diagram illustrating an example of matching between a representation of an object from a captured image with representations of objects in a composite search space.

### DETAILED DESCRIPTION

The systems and methods disclosed herein may relate to using dedicated hardware to perform object recognition. Some configurations of the systems and methods disclosed herein may include using a video motion search engine to accelerate face recognition. Real-time face recognition on a mobile device (e.g., handheld device) may be very challenging with regards to computing performance requirements. Some approaches to face recognition may include mostly server-based software solutions (e.g., an algorithm running on a server with parallel multiple central processing units (CPUs)). In some configurations of the systems and methods disclosed herein, one or more face features (e.g., feature vectors) may be pre-combined in a gallery in a feature-map image. Hardware-accelerated image matching (using a motion search hardware engine within a video encoder, for example) may be used to accelerate face recognition with real-time performance in some configurations. It may be difficult to achieve real-time facial recognition performance on some mobile platforms without the systems and methods disclosed herein.

It should be noted that the systems and methods disclosed herein may be implemented in a wide variety of devices. For example, the systems and methods disclosed herein may be implemented to perform object recognition on stationary and/or mobile platforms. For instance, the systems and methods disclosed herein may be implemented in a home (e.g., a connected home) for a safety and security application in a security system (e.g., Internet protocol (IP) camera). Additionally or alternatively, the systems and methods disclosed herein may be implemented in a mobile device (e.g., handheld device) for real-time facial recognition. In an example, a face detector may be implemented to detect up to 10 faces in an image (from a camera, for instance). In this example, a face recognizer (e.g., face recognition engine) may recognize each of the faces from a 1000-face gallery within a few hundred milliseconds (ms) (before one or detected faces move away, out of camera view, for instance). It should be noted that while facial recognition is given as an example, the systems and methods disclosed herein may be implemented to recognize other kinds of objects (e.g., signs, bodies (e.g., pedestrians), cars, text, buildings, structures, other items, etc.).

In accordance with some configurations of the systems and methods disclosed herein, using existing hardware to accelerate face recognition with much higher performance may enable real-time applications on mobile device-based solutions (versus a server-based solution otherwise). The systems and methods disclosed herein may also offer lower power consumption (e.g., lower battery power consumption) in some configurations. It should be noted that the systems and methods may be implemented on a mobile device, a laptop, a desktop computer, a server, a camera and/or a variety of other devices.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

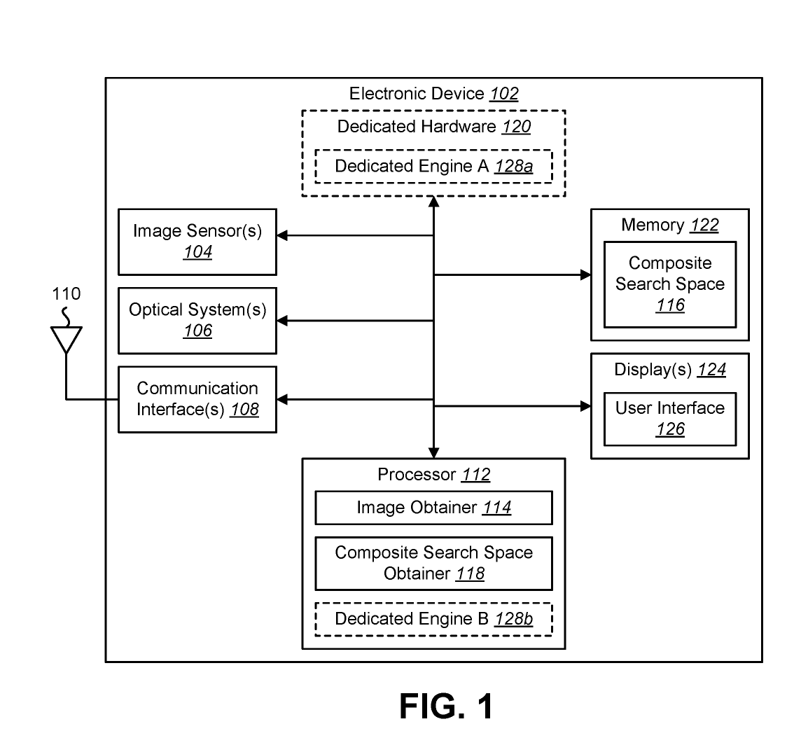

FIG. 1 is a block diagram illustrating one example of an electronic device 102 in which systems and methods for recognizing an object in an image may be implemented. Examples of the electronic device 102 include cameras, video camcorders, digital cameras, cellular phones, smart phones, computers (e.g., desktop computers, laptop computers, etc.), tablet devices, media players, televisions, vehicles, automobiles, personal cameras, wearable cameras, virtual reality devices (e.g., headsets), augmented reality devices (e.g., headsets), mixed reality devices (e.g., headsets), action cameras, surveillance cameras, mounted cameras, connected cameras, robots, aircraft, drones, unmanned aerial vehicles (UAVs), smart appliances, healthcare equipment, gaming consoles, personal digital assistants (PDAs), set-top boxes, appliances, etc. The electronic device 102 may include one or more components or elements. One or more of the components or elements may be implemented in hardware (e.g., circuitry), a combination of hardware and firmware and/or a combination of hardware and software (e.g., a processor with instructions).

In some configurations, the electronic device 102 may perform one or more of the functions, procedures, methods, steps, etc., described in connection with one or more of FIGS. 1-15. Additionally or alternatively, the electronic device 102 may include one or more of the structures described in connection with one or more of FIGS. 1-15.

In some configurations, the electronic device 102 may include a processor 112, a memory 122, a display 124, one or more image sensors 104, one or more optical systems 106, one or more communication interfaces 108 and/or dedicated hardware 120. The processor 112 may be coupled to (e.g., in electronic communication with) the memory 122, display 124, image sensor(s) 104, optical system(s) 106, communication interface(s) 108 and/or dedicated hardware 120. It should be noted that one or more of the elements of the electronic device 102 described in connection with FIG. 1 (e.g., image sensor(s) 104, optical system(s) 106, communication interface(s) 108, dedicated hardware 120, display(s) 124, etc.), may be optional and/or may not be included (e.g., implemented) in the electronic device 102 in some configurations.

The processor 112 may be a general-purpose single- or multi-chip microprocessor (e.g., an Advanced RISC (reduced instruction set computing) Machine (ARM)), a special-purpose microprocessor (e.g., a digital signal processor (DSP)), a microcontroller, a programmable gate array, etc. The processor 112 may be referred to as a central processing unit (CPU). Although the processor 112 is shown in the electronic device 102, in an alternative configuration, a combination of processors (e.g., an image signal processor (ISP) and an application processor, an ARM and a digital signal processor (DSP), etc.) could be used. The processor 112 may be configured to implement one or more of the methods disclosed herein. The processor 112 may include and/or implement an image obtainer 114 and/or a composite search space obtainer 118.

The memory 122 may be any electronic component capable of storing electronic information. For example, the memory 122 may be implemented as random access memory (RAM), read-only memory (ROM), magnetic disk storage media, optical storage media, flash memory devices in RAM, on-board memory included with the processor, EPROM memory, EEPROM memory, registers and so forth, including combinations thereof.

The memory 122 may store instructions and/or data. The processor 112 may access (e.g., read from and/or write to) the memory 122. The instructions may be executable by the processor 112 to implement one or more of the methods described herein. Executing the instructions may involve the use of the data that is stored in the memory 122. When the processor 112 executes the instructions, various portions of the instructions may be loaded onto the processor 112 and/or various pieces of data may be loaded onto the processor 112. Examples of instructions and/or data that may be stored by the memory 122 may include image data, image obtainer 114 instructions and/or composite search space obtainer 118 instructions, etc. In some configurations, the memory 122 may store a composite search space 116. The composite search space 116 will be described in greater detail below.

The communication interface(s) 108 may enable the electronic device 102 to communicate with one or more other electronic devices. For example, the communication interface(s) 108 may provide one or more interfaces for wired and/or wireless communications. In some configurations, the communication interface(s) 108 may be coupled to one or more antennas 110 for transmitting and/or receiving radio frequency (RF) signals. Additionally or alternatively, the communication interface 108 may enable one or more kinds of wireline (e.g., Universal Serial Bus (USB), Ethernet, etc.) communication.

In some configurations, multiple communication interfaces 108 may be implemented and/or utilized. For example, one communication interface 108 may be a cellular (e.g., 3G, Long Term Evolution (LTE), CDMA, etc.) communication interface 108, another communication interface 108 may be an Ethernet interface, another communication interface 108 may be a universal serial bus (USB) interface and yet another communication interface 108 may be a wireless local area network (WLAN) interface (e.g., Institute of Electrical and Electronics Engineers (IEEE) 802.11 interface). In some configurations, the communication interface 108 may send information (e.g., image information, object recognition information, object identifier information, composite search space 116 information, etc.) to and/or receive information from another device (e.g., a vehicle, a smart phone, a camera, a display, a remote server, etc.).

The electronic device 102 (e.g., image obtainer 114) may obtain one or more images (e.g., digital images, image frames, frames, video, captured images, test images, etc.). For example, the electronic device 102 may include the image sensor(s) 104 and the optical system(s) 106 (e.g., lenses) that focus images of scene(s) and/or object(s) that are located within the field of view of the optical system 106 onto the image sensor 104. The optical system(s) 106 may be coupled to and/or controlled by the processor 112 in some configurations. A camera (e.g., a visual spectrum camera or otherwise) may include at least one image sensor and at least one optical system. Accordingly, the electronic device 102 may be one or more cameras and/or may include one or more cameras in some implementations. In some configurations, the image sensor(s) 104 may capture the one or more images (e.g., image frames, video, still images, burst mode images, captured images, test images, etc.).

Additionally or alternatively, the electronic device 102 may request and/or receive the one or more images from another device (e.g., one or more external cameras coupled to the electronic device 102, a network server, traffic camera(s), drop camera(s), vehicle camera(s), web camera(s), etc.). In some configurations, the electronic device 102 may request and/or receive the one or more images (e.g., captured images) via the communication interface 108. For example, the electronic device 102 may or may not include camera(s) (e.g., image sensor(s) 104 and/or optical system(s) 106) and may receive images from one or more remote device(s). One or more of the images (e.g., image frames) may include one or more scene(s) and/or one or more object(s).

In some configurations, the electronic device 102 may include an image data buffer (not shown). The image data buffer may be included in the memory 122 in some configurations. The image data buffer may buffer (e.g., store) image data from the image sensor(s) 104 and/or external camera(s). The buffered image data may be provided to the processor 112.

The display(s) 124 may be integrated into the electronic device 102 and/or may be coupled to the electronic device 102. Examples of the display(s) 124 include liquid crystal display (LCD) screens, light emitting display (LED) screens, organic light emitting display (OLED) screens, plasma screens, cathode ray tube (CRT) screens, etc. In some implementations, the electronic device 102 may be a smartphone with an integrated display. In another example, the electronic device 102 may be coupled to one or more remote displays 124 and/or to one or more remote devices that include one or more displays 124.

In some configurations, the electronic device 102 may include a camera software application. When the camera application is running, images of objects that are located within the field of view of the optical system(s) 106 may be captured by the image sensor(s) 104. The images that are being captured by the image sensor(s) 104 may be presented on the display 124. For example, one or more images may be sent to the display(s) 124 for viewing by a user. In some configurations, these images may be played back from the memory 122, which may include image data of an earlier captured scene. The one or more images obtained by the electronic device 102 may be one or more video frames and/or one or more still images. In some configurations, the display(s) 124 may present a full field of view of the image sensor(s) 104 and/or a zoom region. Additionally or alternatively, the display(s) 124 may present automatically focused images, one or more indicators corresponding to one or more objects of interest (e.g., recognized objects(s)) and/or one or more images (e.g., cropped object(s), zoomed object(s), etc.).

In some configurations, the electronic device 102 may present a user interface 126 on the display 124. For example, the user interface 126 may enable a user to interact with the electronic device 102. In some configurations, the user interface 126 may enable a user to interact with the electronic device 102. For example, the user interface 126 may receive a touch, a mouse click, a gesture and/or some other indication that indicates an input.

The electronic device 102 (e.g., processor 112) may optionally be coupled to, be part of (e.g., be integrated into), include and/or implement one or more kinds of devices. For example, the electronic device 102 may be implemented in a drone equipped with cameras. In another example, the electronic device 102 (e.g., processor 112) may be implemented in an action camera.

The processor 112 may include and/or implement an image obtainer 114. One or more images (e.g., image frames, video, burst shots, captured images, test images, etc.) may be provided to the image obtainer 114. For example, the image obtainer 114 may obtain image frames from one or more image sensors 104. For instance, the image obtainer 114 may receive image data from one or more image sensors 104 and/or from one or more external cameras. As described above, the image(s) (e.g., captured images) may be captured from the image sensor(s) 104 included in the electronic device 102 or may be captured from one or more remote camera(s).

In some configurations, the image obtainer 114 may request and/or receive one or more images (e.g., image frames, etc.). For example, the image obtainer 114 may request and/or receive one or more images from a remote device (e.g., external camera(s), remote server, remote electronic device, etc.) via the communication interface 108.

One or more images obtained by the image obtainer 114 may be captured images. For example, the image obtainer 114 may obtain one or more captured images. A captured image may be image that includes one or more objects for object recognition. Additionally or alternatively, a captured image may include one or more objects for object detection. For example, the processor 112 may include an object detector in some configurations. The object detector may detect the location(s) of one or more objects in the captured image. For example, the object detector may indicate one or more regions of interest (ROIs) of the captured image that may include one or more objects.

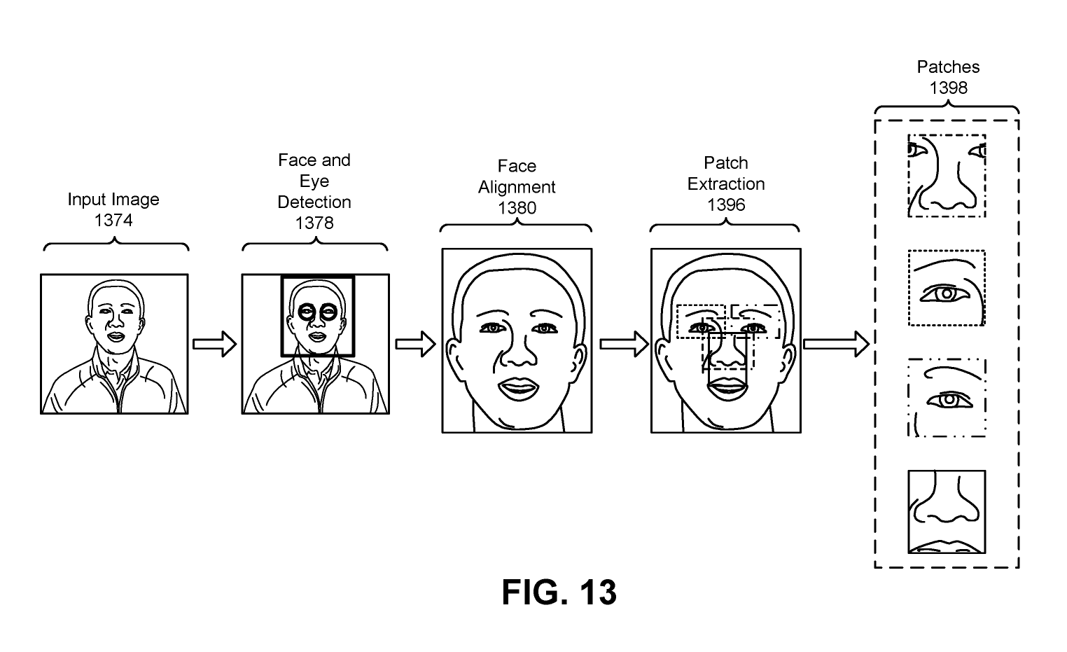

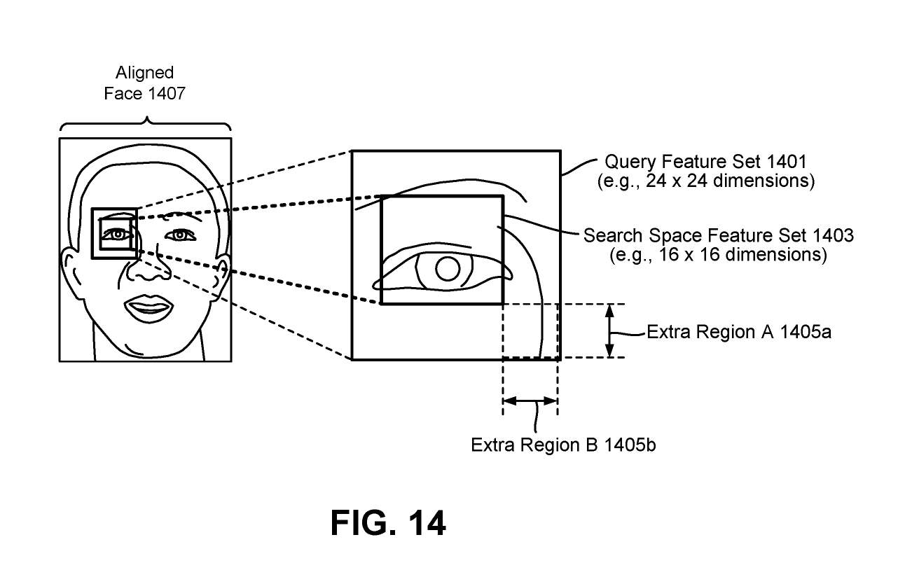

In some configurations, the processor 112 (e.g., image obtainer 114 and/or the composite search space obtainer 118) may determine one or more patches (e.g., subsets) of one or more images. For example, the processor 112 may determine subsets (e.g., pixel subsets) of one or more images. In some configurations, one or more of the patches may be of a predetermined size (e.g., numbers of pixels in two dimensions). Two or more of the patches may overlap and/or two or more of the patches may be mutually exclusive. In some configurations, one or more of the patches may correspond to appearance information (e.g., a location and/or component) of an object. For example, one patch may correspond to a left eye, another patch may correspond to a right eye, another patch may correspond to a nose, another patch may correspond to a mouth, etc., of a face. For instance, 31 patches corresponding to different face locations may be utilized in some configurations. Examples of patch extraction are given in connection with FIG. 13. Patches may be determined for one or more captured images and/or for one or more images for a composite search space 116. In some configurations, the processor 112 (e.g., image obtainer 114 and/or composite search space obtainer 118) may determine one or more feature sets based on one or more images and/or one or more patches. Examples of feature determination (e.g., extraction) are given in connection with FIG. 14. For example, feature sets may be determined for one or more images for a composite search space (e.g., gallery images) and/or for one or more captured images (e.g., images for matching, probe images, etc.). It should be noted that the patches (e.g., a set of patches) for an image may or may not cover the entire image.

The processor 112 may include and/or implement a composite search space obtainer 118. The composite search space obtainer 118 may obtain (e.g., determine and/or receive) a composite search space 116. A composite search space 116 may include information corresponding to a plurality of objects. For example, the composite search space 116 may include a plurality of separate images (and/or a plurality of feature sets based on the plurality of separate images). In some configurations, at least two of the separate images may have been captured at different times and/or locations. In some configurations, two or more of the separate images may be based on different subsets of an image (e.g., may be two or more cropped portions of the same image).

In some configurations, the composite search space 116 may include a plurality of adjacent cells. Each of the adjacent cells may include a representation of an object. A representation of an object may be an image of an object, a subset of an image of an object (e.g., a “patch”), a feature set of an image of an object, or a feature set of a subset of an image of an object (e.g., a feature set of a “patch”). For example, the composite search space 116 may include a plurality of different images. For instance, each of the adjacent cells in the composite search space may contain an entire object (or corresponding feature vector(s)). Additionally or alternatively, the composite search space 116 may include a plurality of feature sets based on a plurality of separate images. Each image in the composite search space 116 may include one object. Each image in the composite search space 116 may be undivided (e.g., whole, not split into subsets or patches, etc.) or may be split into subsets or patches. The composite search space 116 may be referred to as a “gallery” in some examples. Each of the adjacent cells in the composite search space 116 may be uniform or non-uniform. For example, uniform cells may each have the same size (e.g., N×M pixels (where N and M may be the same or different), data size, feature vector size, etc.), while non-uniform cells may have different sizes (e.g., different pixel dimensions, different data sizes, different feature vector sizes, etc.).

In some configurations, the composite search space 116 may be arranged in accordance with an image format (e.g., high efficiency video coding (HEVC) format, H.264, JPEG, etc.). For example, the composite search space 116 may include bits that are arranged in accordance with image format containers. In some configurations, the composite search space 116 may include image information (e.g., pixel data). It should be noted that the composite search space 116 may be arranged in accordance with an image format without including actual image information (e.g., pixel data) in some configurations. For example, the composite search space 116 may include feature sets instead of image information. In a more specific example, the composite search space 116 may include feature sets (e.g., feature vectors, binary vectors, etc.) instead of motion vectors and/or pixel data (e.g., RGB, CMYK, chroma information (e.g., Y, Cb, Cr), hue saturation value (HSV), etc.). In some approaches, the feature sets may be arranged to fit macroblock boundaries and/or compression boundaries. For example, motion search engines may operate in terms of one or more macroblock sizes. The feature sets may be arranged to be sizes in accordance with macroblocks and/or to align with the boundaries of macroblocks.

In some configurations, a composite search space 116 may be provided to the composite search space obtainer 118. For example, the composite search space obtainer 118 may receive a composite search space 116 via the communication interface 108. For example, the electronic device 102 may be coupled to a remote device that may provide a composite search space or information indicating a composite search space. Examples of devices may include cameras, smartphones, computers, tablets, servers, etc.

In some configurations, the composite search space obtainer 118 may generate (e.g., determine, calculate, compute, etc.) the composite search space 116. For example, the composite search space obtainer 118 may obtain a plurality of images (from the image sensor(s) 104 and/or from one or more remote devices, for example). The composite search space obtainer 118 may arrange representations of objects, one or more of the plurality of images, one or more subsets of the plurality of images (e.g., “patches”) and/or one or more feature sets based on the plurality of images (and/or patches, for example) into the composite search space 116. Data in the composite search space 116 that corresponds to an image may be a “region” of the composite search space 116.

In some configurations, the composite search space obtainer 118 may obtain a plurality of images, determine a set of patches for each of the plurality of images, determine a feature set for each of the patches and/or produce the composite search space 116 based on the features sets. A group of patches and/or feature sets corresponding to one image (e.g., object) may represent a “region” of the composite search space in these configurations. A feature set (e.g., feature vector) may be a set of bits (e.g., a binary feature vector, a byte, etc.) in some configurations.

In some configurations, the composite search space obtainer 118 may add to an existing composite search space 116. For example, the electronic device 102 may obtain (e.g., capture, receive, etc.) an image of an object to be added to the composite search space 116. The composite search space obtainer 118 may add the image to the composite search space 116 and/or may determine and add one or more feature sets of the object to the composite search space 116. In some configurations, the composite search space obtainer 118 may add a corresponding entry (e.g., an identifier corresponding to the added region of the composite search space) in a composite search space index.

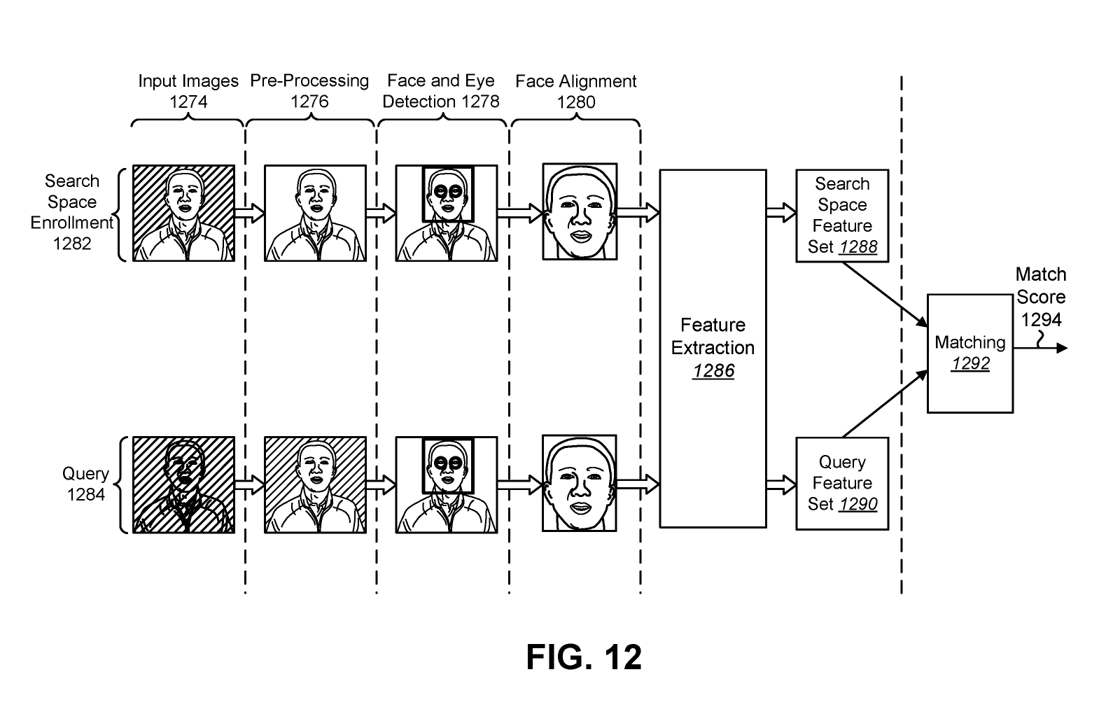

Optionally, the composite search space obtainer 118 may perform one or more additional operations on the plurality of images. For example, the composite search space obtainer 118 may optionally crop, resize and/or normalize each of the plurality of images. For instance, the composite search space obtainer 118 may ensure that each of the plurality of images includes a single object (e.g., face) and/or that each object in each image is approximately the same size. Accordingly, each region of the composite search space may include a single object in some configurations. Additionally or alternatively, each representation of an object may correspond to a whole object (e.g., to a whole region) or may correspond to a subset of an object (e.g., to a patch of an image). Examples of approaches for obtaining a composite search space (e.g., search space enrollment) and/or extracting feature sets are given in connection with FIGS. 12 and 13.

In some configurations, the composite search space obtainer 118 may obtain the composite search space 116 offline. For example, the composite search space 116 may be predetermined and/or may be determined at a time other than run time (e.g., before real-time object recognition is performed). For instance, the composite search space obtainer 718 may determine and/or add information to the composite search space before and/or after run time for performing object recognition.

The electronic device 102 may include dedicated hardware 120 in some configurations. The dedicated hardware 120 may be hardware (e.g., circuitry, a chip, a dedicated processor, an application specific integrated circuit (ASIC), hardware accelerator, etc.) that is configured to perform a dedicated operation. One example of dedicated hardware 120 is a video encoder (e.g., video codec), with a dedicated operation of encoding and/or decoding video. In some configurations, the dedicated operation of the dedicated hardware 120 may not be object recognition. For example, the dedicated hardware 120 may be configured to typically perform only the dedicated operation. More specific examples of a video encoder (e.g., codec) may include an HEVC encoder, H.265 encoder, H.264 encoder, H.263 encoder, etc. In some configurations of the systems and methods disclosed herein, the dedicated hardware 120 may be leveraged (e.g., repurposed) in order to perform object recognition. For example, the dedicated operation of the dedicated hardware may not be object recognition. However, the dedicated engine 128 may be configured to perform object recognition or a matching function of the dedicated engine 128 may be applied for object recognition (in addition to or alternatively from video encoding, for example).

In some configurations of the systems and methods disclosed herein, different data than that typically provided to the dedicated hardware 120 may be input into the dedicated hardware 120. For example, a dedicated video encoder may be designed to receive image data (e.g., pixels, motion vectors, color data, luminance data, etc.). However, feature sets (that are not image data or pixel data, for example) may be input into the dedicated video encoder in some configurations. In other words, feature set data may be input into a dedicated video encoder instead of image data. Additionally or alternatively, a motion search engine may be repurposed to receive feature sets instead of motion vectors, macroblocks and/or image data in some configurations. For example, feature sets may not include motion vectors in some configurations. Accordingly, dedicated hardware 120 may be repurposed to process a different kind of data (instead of the kind of data the dedicated hardware 120 was designed to utilize) in some configurations.

The electronic device 102 may include a dedicated engine 128. In some configurations, dedicated engine A 128a may be included in and/or implemented by the dedicated hardware 120. In other configurations, dedicated engine B 128b may be included in and/or implemented by the processor 112. For example, the processor 112 may include and/or implement a video encoder (by executing instructions (e.g., software) on the processor 112 hardware, for instance), which may include dedicated engine B 128b. When referred to generally (e.g., as dedicated engine 128), the dedicated engine 128 may refer to dedicated engine A 128a and/or dedicated engine B 128b.

The dedicated engine 128 may be configured to perform one or more functions. For example, the dedicated engine 128 may be a motion search engine that is configured to perform motion searching (for dedicated video encoder hardware and/or for a video encoder implemented on the processor 112, for example). In some configurations, the motion search engine of a dedicated video encoder may be configured to perform motion searching in video frames in order to encode (e.g., compress) the video frames. In some configurations, the motion search engine may search for a match in a motion search space. The motion search space may traverse the composite search space 116. For example, the motion search space may move from cell to cell (and/or from region to region, patch to patch, etc.) of the composite search space 116.

The dedicated engine 128 (e.g., dedicated engine A 128a and/or dedicated engine B 128b) may be configured to perform a matching operation between a captured image and the composite search space 116 in order to recognize the object in the captured image. For instance, the dedicated engine 128 may determine metrics (e.g., matching scores) between the captured image and a plurality of regions (e.g., locations corresponding to different objects) in the composite search space 116. In some configurations, the dedicated engine 128 may be configured to match a representation of an object from a captured image with the representations of the objects in the composite search space 116.

In a specific example, dedicated video encoder hardware may have a dedicated operation of video encoding and decoding, not object recognition. In accordance with the systems and methods disclosed herein, the motion search engine of dedicated video encoder hardware may be configured to perform object recognition. For example, the motion search engine may be configured to perform matching between a captured image and the composite search space 116.

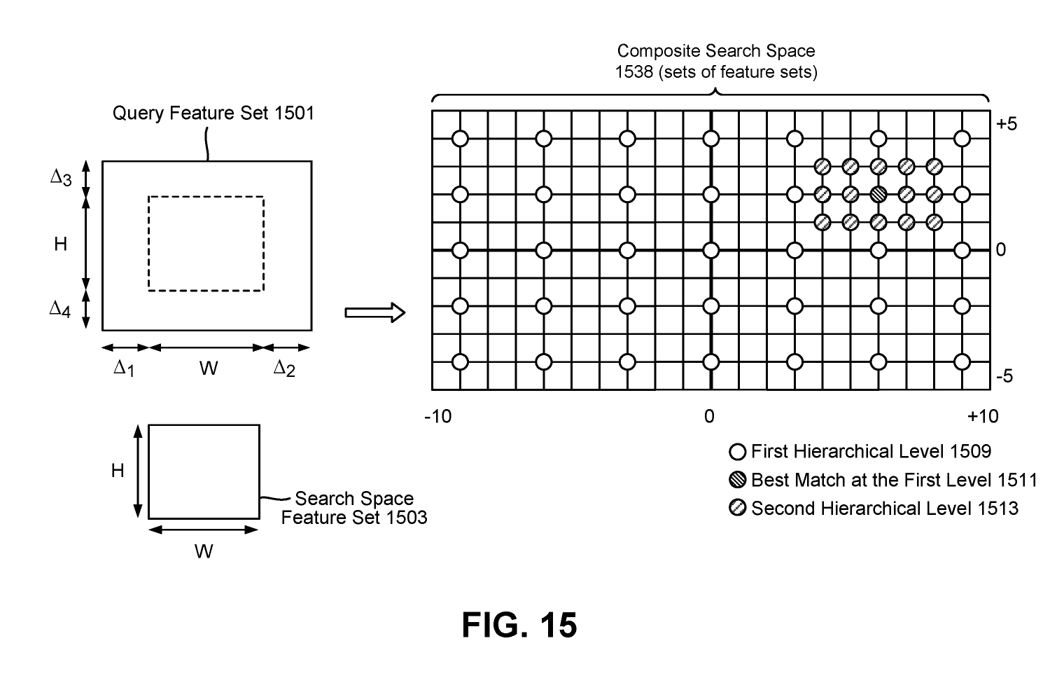

The dedicated engine 128 may determine a matching region (e.g., a best matching region) in the composite search space 116. For example, the dedicated engine 128 may select a matching region based on the metrics corresponding to each of the regions in the composite search space. In some configurations, the dedicated engine 128 may determine a sum of absolute differences (SAD) between the captured image and a plurality of regions in the composite search space 116. For instance, the region with the lowest SAD score and/or a SAD score below a threshold may indicate the best matching region. In some examples, the lowest SAD score that is also below a threshold may indicate a matching region. It should be noted that other metrics may be utilized. For example, a correlation metric may be utilized in some configurations. The region with the highest correlation metric and/or a correlation metric that is above a threshold may indicate the best matching region in these configurations. In some examples, the highest correlation score that is also above a threshold may indicate a matching region. An example of determining the matching region is given in connection with FIG. 15.

In some configurations, the dedicated engine 128 may determine combined scores based on a combination of patch scores (e.g., feature set score). The dedicated engine 128 may perform matching for each of the captured image patches (e.g., feature sets) with respect to each set of feature sets in the composite search space 116. A score for each composite search space 116 region may be based on a combination of patch scores. The region with a combined score indicating a best match may be the best matching region. For example, assume that 31 patches and feature sets are determined for a captured image (e.g., 31 representations of an object for each captured image). Further assume that the composite search space 116 represents 1000 faces. The composite search space 116 may include 31 sets of 1000 feature sets. In this example, the dedicated engine 128 may determine (e.g., calculate, compute, etc.) 31 matching scores corresponding to the 31 patches of the captured image for each of the 1000 regions of the composite search space. Each group of 31 patch scores may be combined to yield a combined score for the corresponding region, resulting in 1000 scores. The region with the score indicating the best match may be the best matching region. An example of determining the matching region is given in connection with FIG. 15.

The dedicated engine 128 may indicate the matching region (e.g., the best matching region). For example, the dedicated engine 128 may provide an indicator to the processor 112 that indicates the location (e.g., data pointer, address, pixel address, array index, etc.) of the matching region in the composite search space.

In some configurations, each region may correspond to an identifier (e.g., a name corresponding to the region). In some approaches, the processor 112 may determine an identifier corresponding to the best matching region. For example, the memory 122 may include a search space index (e.g., table, list, look-up table, etc.) that indicates a correspondence between each region in the composite search space 116 and an identifier. For instance, the processor 112 may look up the identifier corresponding to the region (e.g., location of the region). In some configurations, the identifiers may be names of people corresponding to faces. For example, a particular region may include an image of or feature set(s) corresponding to a face. When the captured image matches the region in the composite search space, the processor 112 may look up the name of the person's face.

In some configurations, the electronic device 102 may present the identifier. For example, the electronic device 102 may present the name of the recognized person on the display 124 on or near the person appearing in the image.

It should be noted that one or more of the operations described herein may be performed for multiple captured images. For example, the dedicated engine 128 may perform matching between multiple captured images and the composite search space 116. For example, the dedicated engine 128 may determine a matching region (e.g., best matching region) for each of the captured images. The processor 112 may determine an identifier corresponding to each of the matching regions. In some configurations, the electronic device 102 may present the identifiers on the display. For example, each of the identifiers may be presented on or near the matching objects in the presented image (e.g., captured image).

It should be noted that in some configurations, a dedicated engine (e.g., a motion search engine of a video processor (e.g., video encoder, video codec, etc.)) may not be used during video decoding. For example, the motion search engine may only be utilized during video encoding. Accordingly, the motion search engine of a video encoder may be utilized during video decoding to perform object recognition. It should be noted that in some configurations, multiple uses of the motion search engine may potentially conflict only when object recognition (e.g., face recognition) is performed at same time as video recording. In particular, while video encoding may utilize the motion search engine, video decoding may not utilize the motion search engine. Accordingly, video playback may not produce a conflict for the motion search engine when object recognition is performed concurrently.

In some configurations, time sharing and/or task sharing for the dedicated engine 128 may be implemented. More specifically, the dedicated engine 128 may perform multiple tasks over a time period (e.g., may perform different tasks in different time cycles in the time period). For example, the motion search engine of a video encoder may be used for object recognition while video is also being encoded by the video encoder (e.g., the motion search engine may be shared by a video encoder and face recognition). For instance, assume a scenario in a surveillance use case where video is being captured and encoded and where there is a concurrent need to detect one or more faces in the video, recognize the face(s) and/or perhaps tag the encoded video with the recognized face tag(s). Such a concurrent use case may be achievable. During encoding, for example, the duration of time within a frame when the motion engine is busy versus the other engines in the encoder processing pipeline may be less than a frame time. Accordingly, the remaining time may be utilized by the motion search engine to perform face recognition. In such a scenario, it is possible that instead of doing X face recognitions per second, performance may be reduced (e.g., less than X, much less than X, etc.), but the overall approach would still work.

In some configurations, a video motion search engine may have a much higher performance capability than would be needed for object recognition (e.g., face recognition). For example, a video motion search engine may be implemented to support 4K video (e.g., Digital Cinema Initiatives (DCI) 4096×2160) at 60 frames/second. For instance, the video motion search engine may need to complete at least a 34,560 megabyte (MB) search (e.g., each MB 16×16 pixels) within 15 milliseconds (ms) for a P-frame. The video motion search engine may need twice this capability for a B-frame (e.g., each MB may make 2 motion searches, with different reference frames). The video motion search engine may even need a higher capability than that if each MB may be searched for multiple candidate reference frames. It may also need additional capability to handle a sub-MB search (e.g., each 8×8 pixel within a MB) and/or additional capability to handle a sub-pixel search. Some configurations of the systems and methods disclosed herein may use only a small fraction of the motion search engine capability and functionality to support object recognition (e.g., face recognition). Accordingly, using the motion search engine to support object recognition (e.g., face recognition) as multi-task in a time sharing manner may be implemented.

It should be noted that the dedicated engine 128 (e.g., motion search engine) may be implemented to search multiple frames concurrently in some configurations. While this is a beneficial feature, the motion search engine may be utilized to accelerate object recognition (e.g., face recognition) even without a concurrent multi-frame search capability in some configurations.

It should be noted that one or more of the elements or components of the electronic device 102 may be combined and/or divided. For example, the image obtainer 114 and/or the composite search space obtainer 118 may be combined. Additionally or alternatively, one or more of the image obtainer 114 and/or the composite search space obtainer 118 may be divided into elements or components that perform a subset of the operations thereof.

Some configurations of the systems and methods disclosed herein may provide a face recognition solution. In one approach, a detected face may be normalized to the same size (as faces corresponding to a composite search space 116). In an example, 31 sets of feature sets are generated. Each feature set may be matched to each of 1000 pre-computed feature sets in the composite search space (e.g., gallery) to find the best match by comparing a score with a threshold to determine whether the feature set represents the same person.

In some configurations, a motion search may be performed to find the best matching face. For example, some configurations of the systems and methods disclosed herein may combine feature sets (e.g., pre-computed gallery features) into one composite search space 116 (e.g., feature-map image). In some implementations, a total of 31 sets of features sets (e.g., feature images) may be utilized for facial recognition. Existing motion search engine hardware for a video encoder may be used to match each computed feature set from detected face through the corresponding set of feature sets (e.g., feature-map image).

In some configurations, the hardware video encoder may need to handle 1080p at 30 frames per second. In accordance with the systems and methods disclosed herein, this requirement may be met, since video hardware may deliver much higher performance than this. For example, a video encoder may perform an 8100 megabyte (MB) motion search within each frame. This may provide the capability of matching about 90 faces in each frame, frame by frame for 30 frames per second (e.g., 30 milliseconds (ms) per frame). Some configurations of the systems and methods disclosed herein may offer much better performance than a general software-based solution. Accordingly, some configurations of the systems and methods disclosed herein may enable recognizing an object with video encoder and/or decoder hardware. Some configurations of the systems and methods disclosed herein may be beneficial, since existing dedicated hardware may be repurposed, rather than needing to design new hardware (e.g., chips, circuitry, etc.) to handle object recognition.

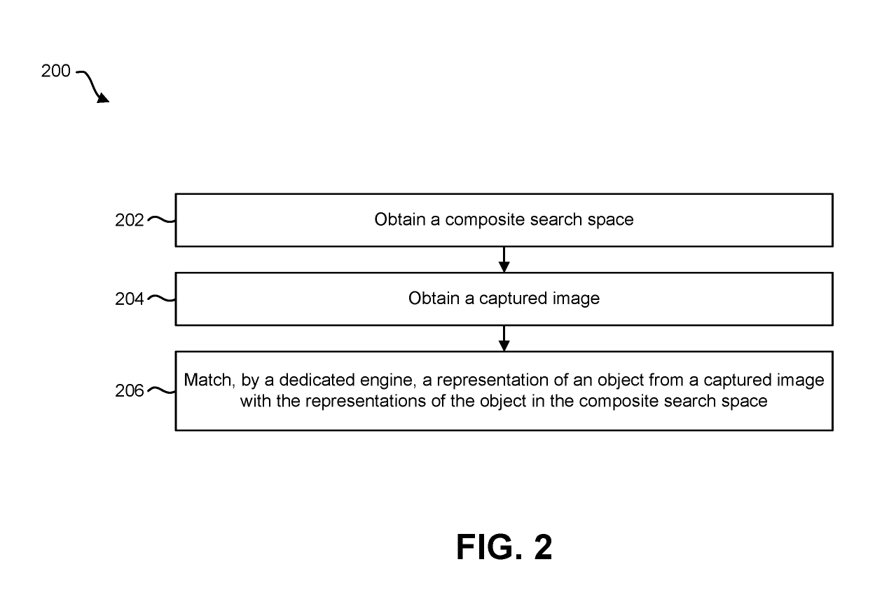

FIG. 2 is a flow diagram illustrating one configuration of a method 200 for recognizing an object in an image. The method 200 may be performed by an electronic device (e.g., the electronic device 102 described in connection with FIG. 1).

The electronic device 102 may obtain 202 a composite search space. This may be accomplished as described in connection with FIG. 1. For example, the electronic device 102 may receive the composite search space and/or generate the composite search space.

The electronic device 102 may obtain 204 a captured image. This may be accomplished as described in connection with FIG. 1. For example, the electronic device 102 may capture one or more captured images with one or more image sensors 104 and/or may receive one or more captured images from one or more remote devices.

The electronic device 102 may match 206, by a dedicated engine (e.g., dedicated engine A 128a and/or dedicated engine B 128b), a representation of an object from the captured image with the representations of the object in the composite search space. Performing 206 object recognition may be accomplished as described in connection with FIG. 1. For example, the dedicated engine 128 may perform matching based on the captured image (e.g., feature set(s) based on the captured image) and the composite search space. For example, the dedicated engine 128 may determine one or more metrics (e.g., SADs, correlations, etc.) and select the matching region based on the metric(s). The dedicated engine 128 may indicate a matching region (e.g., best matching region) in the composite search space. An example of an approach for matching 206 is provided in connection with FIG. 15.

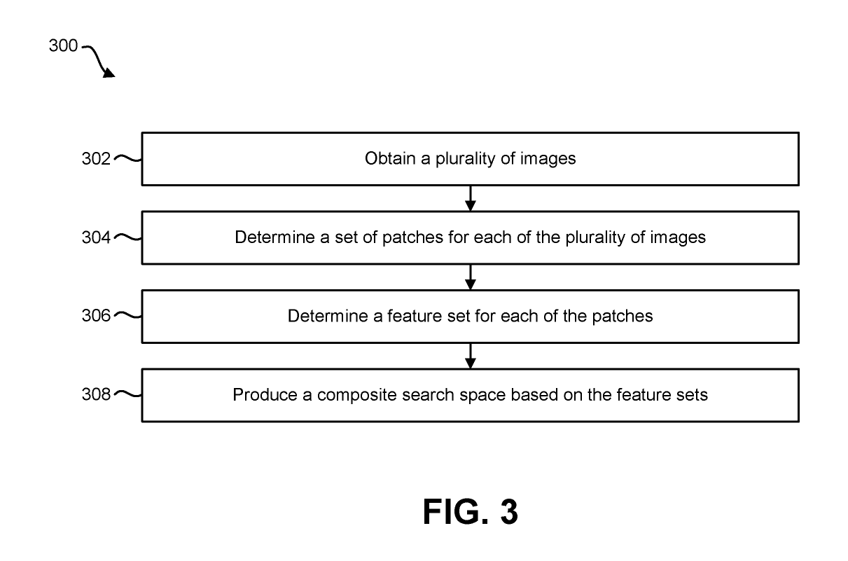

FIG. 3 is a flow diagram illustrating one configuration of a method 300 for generating a composite search space. The method 300 may be performed by an electronic device (e.g., the electronic device 102 described in connection with FIG. 1).

The electronic device 102 may obtain 302 a plurality of images. This may be accomplished as described in connection with FIG. 1. For example, the electronic device 102 may capture one or more images with one or more image sensors 104 and/or may receive one or more images from one or more remote devices.

The electronic device 102 may optionally perform one or more additional operations on the plurality of images. For example, the electronic device 102 may optionally crop, resize and/or normalize each of the plurality of images. This may be accomplished as described in connection with FIG. 1. Further examples are provided in connection with FIGS. 12 and 13.

The electronic device 102 (e.g., composite search space obtainer 118) may determine 304 a set of patches for each of the plurality of images. A patch may be a portion (e.g., subset) of an image. For example, the electronic device 102 may determine a plurality of subsets of each of the plurality of images. In some configurations, each patch may be 24×24 pixels in size. Other sizes may be utilized. The patches may be the same size or different sizes. In one example, the electronic device 102 may determine 31 patches for each of the plurality of images. An example of patch determination (e.g., extraction) is given in connection with FIG. 13.

The electronic device 102 may determine 306 a feature set for each of the patches. This may be accomplished as described in connection with FIG. 1. For example, determining 306 a feature set for each of the patches may include performing spatial filtering on the patches to produce feature sets. For instance, the electronic device 102 may perform illumination invariant feature encoding through spatial filtering.

The electronic device 102 may produce 308 a composite search space based on the feature sets. This may be accomplished as described in connection with FIG. 1. For example, the electronic device 102 may arrange the features sets into a composite search space. For instance, the electronic device 102 may arrange the feature sets in accordance with an image format (e.g., may insert the feature sets in image format containers). In configurations where feature sets are not utilized, the electronic device 102 may alternatively stitch the plurality of images and/or patches of the plurality of images into the composite search space. In some approaches, the composite search space may be viewed as an image and/or as data formatted to mimic an image format. In some configurations, the electronic device 102 may arrange the feature sets in accordance with one or more macroblock sizes and/or along macroblock boundaries. In some configurations, the electronic device 102 may determine representations (e.g., images, patches of images, feature sets of images, feature sets of patches, etc.) of objects. The representations (e.g., images, patches of images, feature sets of images, feature sets of patches, etc.) may be arranged to produce the composite search space.

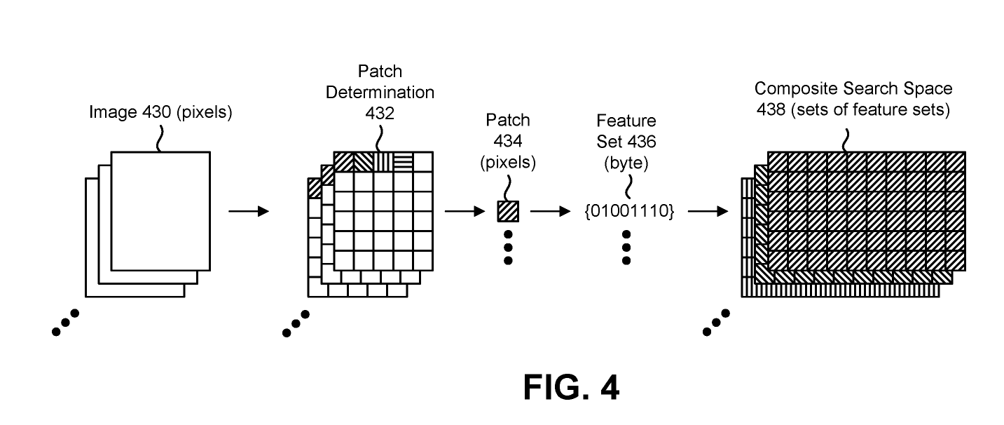

FIG. 4 is a diagram illustrating one example of generating a composite search space 438. The example described in connection with FIG. 4 may be one example of generating a composite search space 438 as described in connection with FIG. 1. In particular, FIG. 4 illustrates a plurality of images 430. Each of the images 430 may be sets of pixels (e.g., pixel data). The electronic device 102 may obtain the plurality of images 430. In some configurations, the images 430 may be normalized such that objects corresponding to each of the images 430 are approximately the same size.

The electronic device 102 (e.g., composite search space obtainer 118) may determine 432 a set of patches 434 for each of the plurality of images 430. For example, the electronic device 102 may determine a plurality of subsets for each of the images 430. In the example given in FIG. 4, 30 patches 434 are determined 432 for each of the images 430. It should be noted that a different number of patches may be utilized (e.g., 31 patches). The patches may or may not be uniformly distributed. The patches may or may not cover the whole image in some approaches. The patches may or may not overlap. In some configurations, each of the patches may correspond to a component location of an object (e.g., eyes, nose, mouth, etc., of a face).

The electronic device 102 may determine a feature set 436 corresponding to each of the patches 434. Each feature set 436 may be a representation of an object (e.g., of a subset of an image of the object). In the example given in FIG. 4, each feature set 436 is a binary feature vector (e.g., a byte). It should be noted that the feature set 436 may include 8 bits or a different number of bits. In some configurations, feature sets may or may not be binary vectors and/or may have different dimensions.

The electronic device 102 may arrange the feature sets 436 into a composite search space 438. In the example given in FIG. 4, the composite search space 438 includes sets of feature sets. For instance, feature sets 436 corresponding to the same patch 434 of each image 430 may be arranged into a set of feature sets. In a specific example, feature sets corresponding to each of the upper left patches from all of the images 430 may be arranged into one set of feature sets. A set of feature sets may be generated for each of the patches. For example, 30 sets of feature sets may be generated, since each image is split into 30 patches 434. When performing matching with the composite search space 438, the electronic device 102 (e.g., dedicated engine 128) may compare (e.g., score) the captured image patch (e.g., feature set 436 corresponding to the captured image patch) based on each respective set of patches (e.g., set of feature sets 436) of the composite search space 438.

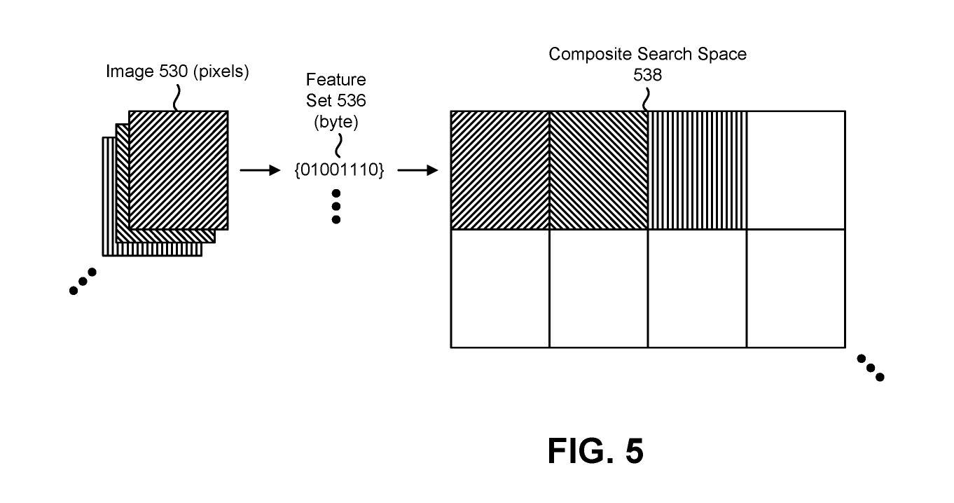

FIG. 5 is a diagram illustrating another example of generating a composite search space 538. The example described in connection with FIG. 5 may be one example of generating a composite search space 538 as described in connection with FIG. 1. In particular, FIG. 5 illustrates a plurality of images 530. Each of the images 530 may be sets of pixels (e.g., pixel data). The electronic device 102 may obtain the plurality of images 530. In some configurations, the images 530 may be normalized such that objects corresponding to each of the images 530 are approximately the same size.

The electronic device 102 may determine a feature set 536 corresponding to each of the patches 534. Each feature set 536 may be a representation of an object (e.g., of an image of the object). In the example given in FIG. 5, each feature set is a binary feature vector (e.g., a byte). It should be noted that the feature set 536 may 8 bits or a different number of (e.g., more or fewer) bits.

The electronic device 102 may arrange the feature sets 536 into a composite search space 538. In the example given in FIG. 5, the composite search space 538 includes a set of feature sets. For instance, feature sets 536 corresponding to each image 530 may be arranged into a set of feature sets. When performing matching with the composite search space 538, the electronic device 102 (e.g., dedicated engine 128) may compare the captured image (e.g., feature set 536 corresponding to the captured image) to each of the regions (e.g., feature sets 536) of the composite search space 538.

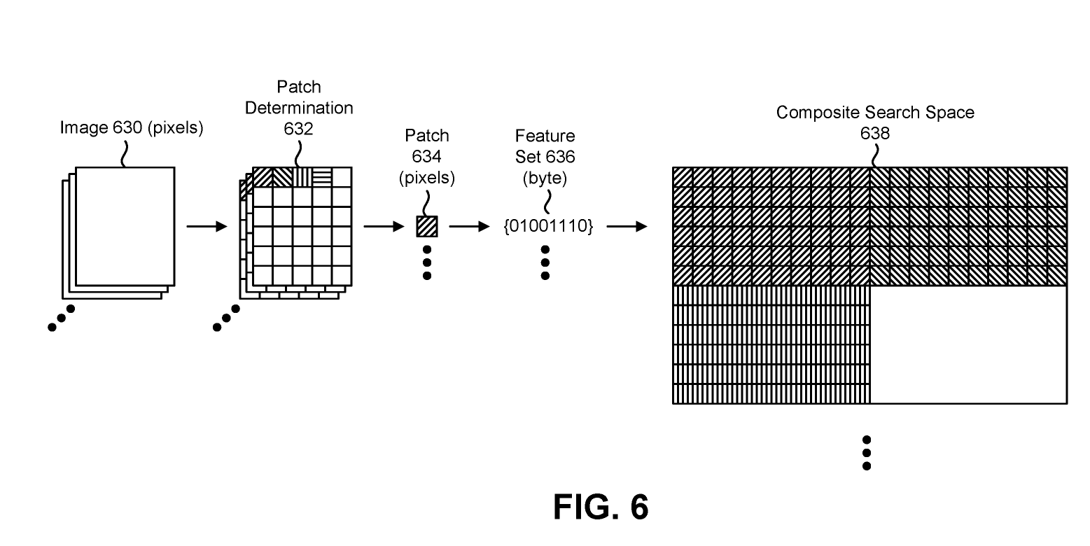

FIG. 6 is a diagram illustrating another example of generating a composite search space 638. In particular, FIG. 6 illustrates a plurality of images 630. Each of the images 630 may be sets of pixels (e.g., pixel data). The electronic device 102 may obtain the plurality of images 630. In some configurations, the images 630 may be normalized such that objects corresponding to each of the images 630 are approximately the same size.

The electronic device 102 (e.g., composite search space obtainer 118) may determine 632 a set of patches 634 for each of the plurality of images 630. For example, the electronic device 102 may determine a plurality of subsets for each of the images 630. In the example given in FIG. 6, 30 patches 634 are determined 632 for each of the images 630.

The electronic device 102 may determine a feature set 636 corresponding to each of the patches 634. Each feature set 636 may be a representation of an object (e.g., of a subset of an image of the object). In the example given in FIG. 6, each feature set is a binary feature vector (e.g., a byte). It should be noted that the feature set 636 may include 8 bits or a different number of bits.

The electronic device 102 may arrange the feature sets 636 into a composite search space 638. In the example given in FIG. 6, the composite search space 638 includes sections of feature sets. For instance, feature sets 636 corresponding to the same patch 634 of each image 630 may be arranged into sections of feature sets. In a specific example, feature sets corresponding to each of the upper left patches may be arranged into one section of feature sets. A section of feature sets may be generated for each of the patches. For example, 30 sections of feature sets may be generated, since each image is split into 30 patches 634. When performing matching with the composite search space 638, the electronic device 102 (e.g., dedicated engine 128) may limit the comparison (e.g., scoring) for one patch (e.g., feature set 636) of the captured image to a corresponding section of the composite search space 638.

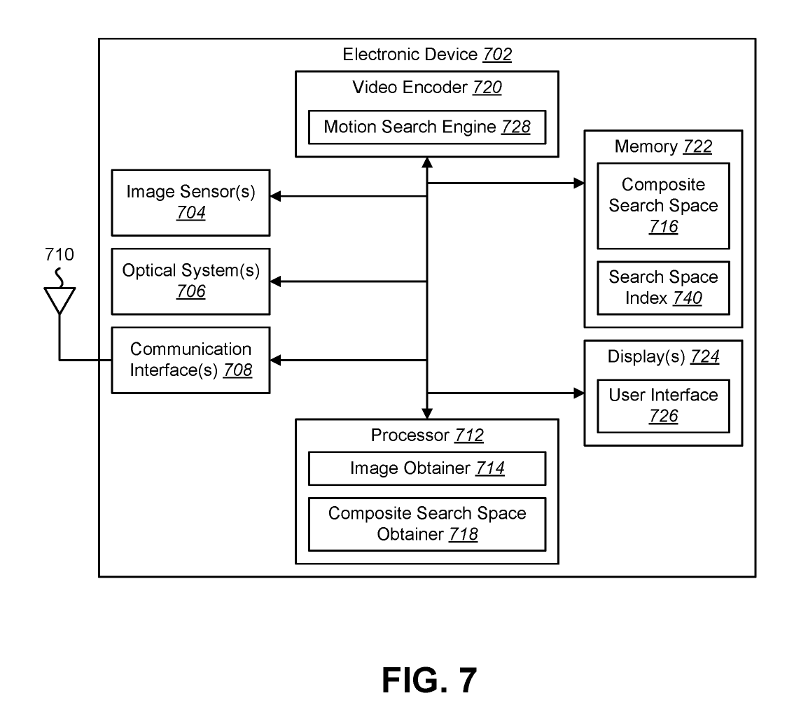

FIG. 7 is a block diagram illustrating a more specific example of an electronic device 702 in which systems and methods for recognizing an object in an image may be implemented. The electronic device 702 described in connection with FIG. 7 may be an example of the electronic device 102 described in connection with FIG. 1. The electronic device 702 may include one or more components or elements. One or more of the components or elements may be implemented in hardware (e.g., circuitry), a combination of hardware and firmware and/or a combination of hardware and software (e.g., a processor with instructions).

In some configurations, the electronic device 702 may perform one or more of the functions, procedures, methods, steps, etc., described in connection with one or more of FIGS. 1-15. Additionally or alternatively, the electronic device 702 may include one or more of the structures described in connection with one or more of FIGS. 1-15.

In some configurations, the electronic device 702 may include a processor 712, a memory 722, a display 724, one or more image sensors 704, one or more optical systems 706, one or more communication interfaces 708 and/or a video encoder 720. The processor 712 may be coupled to (e.g., in electronic communication with) the memory 722, display 724, image sensor(s) 704, optical system(s) 706, communication interface(s) 708 and/or video encoder 720. It should be noted that one or more of the elements of the electronic device 702 described in connection with FIG. 7 (e.g., image sensor(s) 704, optical system(s) 706, communication interface(s) 708, display(s) 724, etc.) may be optional and/or may not be included (e.g., implemented) in the electronic device 702 in some configurations.

The processor 712 may be an example of the processor 112 described in connection with FIG. 1. The processor 712 may be configured to implement one or more of the methods disclosed herein. The processor 712 may include and/or implement an image obtainer 714 and/or a composite search space obtainer 718.

The memory 722 may be an example of the memory 122 described in connection with FIG. 1. The memory 722 may store instructions and/or data. The processor 712 may access (e.g., read from and/or write to) the memory 722. The instructions may be executable by the processor 712 to implement one or more of the methods described herein. Examples of instructions and/or data that may be stored by the memory 722 may include image data, image obtainer 714 instructions and/or composite search space obtainer 718 instructions, etc. In some configurations, the memory 722 may store a composite search space 716 and/or a search space index 740.

The communication interface(s) 708 may enable the electronic device 702 to communicate with one or more other electronic devices. The communication interface(s) 708 may be an example of the communication interface(s) 108 described in connection with FIG. 1.

The display(s) 724 may be integrated into the electronic device 702 and/or may be coupled to the electronic device 702. The display(s) 724 may be an example of the display(s) 124 described in connection with FIG. 1. In some configurations, the electronic device 702 may present a user interface 726 on the display 724 as described in connection with FIG. 1.

The processor 712 may include and/or implement an image obtainer 714 and/or a composite search space obtainer 718. The image obtainer 714 and/or composite search space obtainer 718 may function similarly to corresponding elements described in connection with FIG. 1. For example, the image obtainer 714 may obtain one or more captured images and/or one or more images for a composite search space 716. The composite search space obtainer 718 may obtain (e.g., determine and/or receive) a composite search space 716.

In some configurations, the composite search space obtainer 718 may obtain a search space index 740. The search space index may be an index (e.g., table, list, look-up table, etc.) that indicates a correspondence between each region in the composite search space and an identifier (e.g., names corresponding to regions of the composite search space that correspond to faces). In some configurations, the composite search space obtainer 718 may receive the search space index 740 from another device. Additionally or alternatively, the composite search space obtainer 718 may determine (e.g., generate) the search space index 740. For example, the composite search space obtainer 718 may obtain an identifier corresponding to an image and/or region of the composite search space 716. In some approaches, it may be beneficial to create and/or add information to the composite search space 716 and/or the search space index 740. For example, a user may desire to add a new person to facial recognition capability of the electronic device 702. The electronic device 702 may capture an image of the person (e.g., the person's face) and request and/or receive a name corresponding to the person. For example, the user interface 726 may present a request for the person's name and/or receive input (e.g., text) indicating the person's name. The composite search space obtainer 718 may add the person's face image (e.g., feature set(s)) to the composite search space 716. The composite search space obtainer 718 may add the name in the search space index 740 (with an index value that indicates a correspondence to the region in the composite search space 716).

The electronic device 702 may include a video encoder 720 (e.g., video codec). The video encoder 720 may be an example of the dedicated hardware 120 described in connection with FIG. 1. The video encoder 720 may have a dedicated operation of encoding and decoding video. For example, the video encoder 720 may encode video for transmission and/or storage. Additionally or alternatively, the video encoder 720 may decode video (e.g., stored video, received video, video streams, etc.). The dedicated operation of the video encoder 720 may not be object recognition. For example, the typical operation for the video encoder 720 may include only video encoding and/or decoding. For instance, the video encoder 720 may encode video frames captured by the image sensor(s) 704. More specific examples of a video encoder 720 (e.g., codec) may include an HEVC encoder, H.265 encoder, H.264 encoder, H.263 encoder, etc.

The video encoder 720 may include a motion search engine 728. The motion search engine 728 may be configured to perform one or more functions in order to perform the dedicated operation. For example, the motion search engine of the dedicated video encoder 720 may be configured to perform motion searching in video frames in order to encode (e.g., compress) the video frames.

In some configurations of the systems and methods disclosed herein, the video encoder 720 may be leveraged (e.g., repurposed) in order to perform object recognition. For example, the motion search engine 728 may be configured to perform object recognition. For instance, the motion search engine 728 may be configured to perform a matching operation between a captured image and the composite search space 716 in order to recognize the object in the captured image. In some configurations, the motion search engine 728 may determine metrics (e.g., matching scores) between the captured image and a plurality of regions (e.g., locations corresponding to different objects) in the composite search space 716. For example, the motion search engine 728 may determine one or more SADs and/or correlation metrics (e.g., matching scores) as described herein.

The motion search engine 728 may determine a matching region (e.g., a best matching region) in the composite search space. For example, the motion search engine 728 may select a matching region based on the metrics corresponding to each of the regions in the composite search space as described herein.

The motion search engine 728 may indicate the matching region (e.g., the best matching region). For example, the motion search engine 728 may provide an indicator to the processor 712 that indicates the location (e.g., data pointer, address, pixel address, array index, etc.) of the matching region in the composite search space.

The processor 712 may determine an identifier corresponding to the best matching region. For example, the memory 722 may include the search space index 740 (e.g., table, list, look-up table, etc.) that indicates a correspondence between each region in the composite search space 716 and an identifier. For instance, the processor 712 may look up the identifier corresponding to the region (e.g., location of the region). Examples of identifiers may include names of people, sign types, object types and types of goods (e.g., grocery products, store items, books, movies, etc.). For example, a particular region may include an image of or feature set(s) corresponding to a box of crackers, a book, a toy, a street sign, a business sign, a word, etc. When the captured image matches the region in the composite search space, the processor 712 may look up the identifier of the corresponding object.

In some configurations, the electronic device 702 may present the identifier. For example, the electronic device 702 may present the identifier of the object on the display 724 on or near the object appearing in the image. It should be noted that one or more of the operations described herein may be performed for multiple captured images as described herein.

It should be noted that one or more of the elements or components of the electronic device 702 may be combined and/or divided. For example, the image obtainer 714 and/or the composite search space obtainer 718 may be combined. Additionally or alternatively, one or more of the image obtainer 714 and/or the composite search space obtainer 718 may be divided into elements or components that perform a subset of the operations thereof.

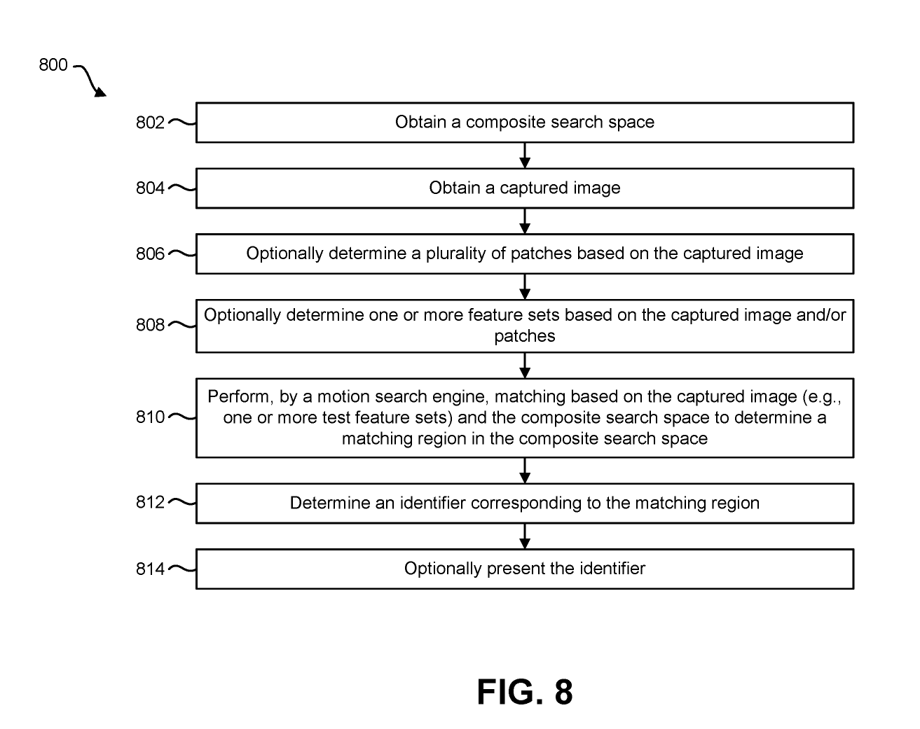

FIG. 8 is a flow diagram illustrating a more specific configuration of a method 800 for recognizing an object in an image. The method 800 may be performed by an electronic device (e.g., the electronic device 102 described in connection with FIG. 1 and/or the electronic device 702 described in connection with FIG. 7).

The electronic device 102 may obtain 802 a composite search space. In some configurations, this may be accomplished as described in connection with one or more of FIGS. 1-7, 12-13 and 15. For example, the electronic device 102 may receive the composite search space and/or generate the composite search space.

The electronic device 102 may obtain 804 a captured image. In some configurations, this may be accomplished as described in connection with one or more of FIGS. 1-2, 7, 12 and 14. For example, the electronic device 102 may capture one or more captured images with one or more image sensors 104 and/or may receive one or more captured images from one or more remote devices.

The electronic device 102 may optionally determine 806 a plurality of patches based on the captured image. In some configurations, this may be accomplished as described in connection with one or more of FIGS. 1, 9, 12 and 14. For example, the electronic device 102 (e.g., processor 112, image obtainer 114 and/or composite search space obtainer 118) may determine one or more patches (e.g., subsets) of the captured image. It should be noted that the patches (e.g., feature sets based on patches) of the captured image may be the same size and/or format as patches (e.g., feature sets based on patches) in the composite search space in some configurations.

The electronic device 102 may optionally determine 808 one or more feature sets based on the captured image and/or patches of the captured image. In some configurations, this may be accomplished as described in connection with one or more of FIGS. 1, 9, 12 and 14. For example, the electronic device 102 may convert the captured image and/or patches into one or more feature vectors (e.g., bytes). In some configurations, each feature set may be a representation of an object (e.g., of a subset of an image of the object).

The electronic device 102 may perform 810, by a motion search engine, matching based on a captured image (e.g., one or more feature sets) and the composite search space to determine a matching region in the composite search space. In some configurations, this may be accomplished as described above in connection with one or more of FIGS. 1-2, 7 and 15. For example, the electronic device 102 may determine metrics (e.g., SADs, correlations, etc.) that indicate a measure of similarity between the captured image (e.g., captured image patches, feature sets, etc.) and the regions of the composite search space (e.g., patches, feature sets, etc.). The region with the metric that indicates a best match (e.g., most similarity) may be the matching region.

The electronic device 102 may determine 812 an identifier corresponding to the matching region. In some configurations, this may be accomplished as described above in connection with one or more of FIGS. 1, 7 and 15. For example, the electronic device 102 may look up the identifier corresponding to the matching region (e.g., location of the region).

The electronic device 102 may optionally present 814 the identifier. For example, the electronic device 102 may present the name of a recognized person on the display 124 on or near the person appearing in the image. Additionally or alternatively, the electronic device 102 may perform one or more other operations based on the identifier. For example, the electronic device 102 may provide a notification (to a vehicle driver, for instance) that the vehicle is approaching a stop sign, a street with a particular name, a pedestrian and/or some other object. Additionally or alternatively, the electronic device 102 may control a vehicle (e.g., apply brakes, honk a vehicle horn, turn on headlights, etc.). In another configuration, the electronic device 102 may output a word (e.g., spoken word) corresponding to recognized text (e.g., read text aloud).

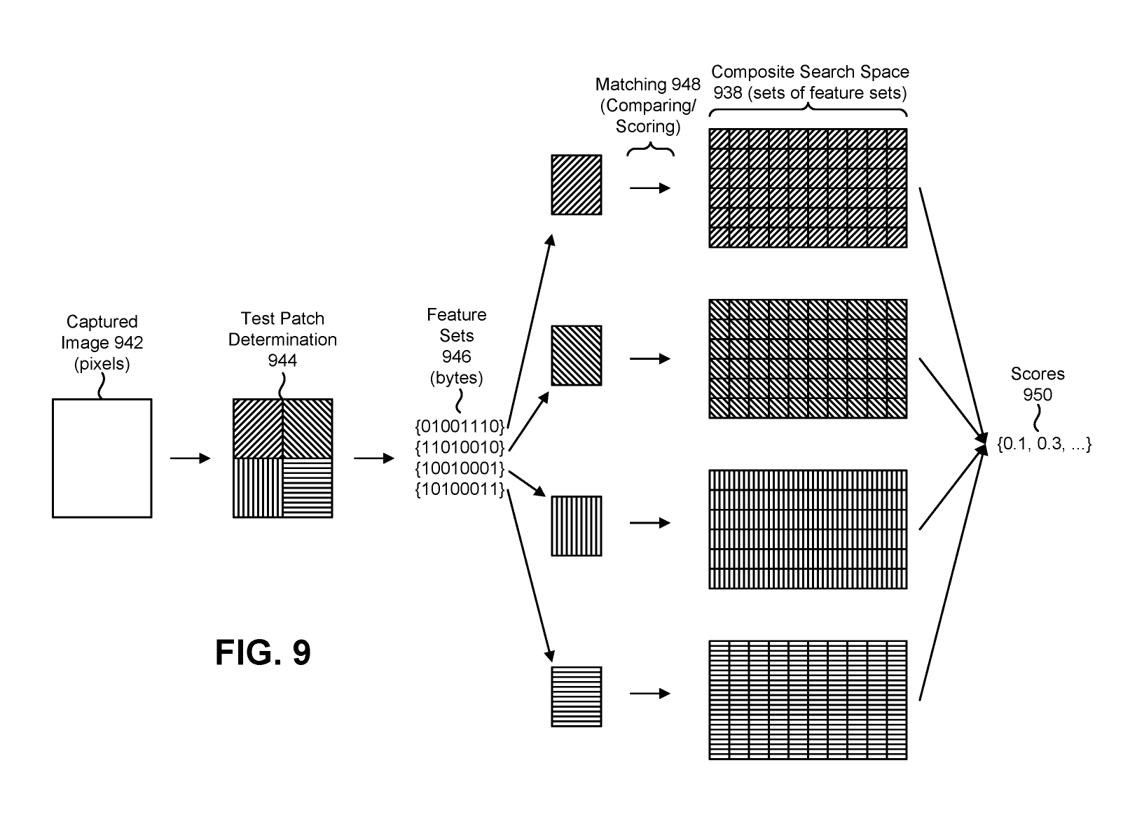

FIG. 9 is a diagram illustrating one example of operations that may be performed for recognizing an object in an image in accordance with the systems and methods disclosed herein. The example described in connection with FIG. 9 may be one example of operations that may be performed for recognizing an object in an image as described in connection with FIG. 1. In particular, FIG. 9 illustrates a captured image 942. The captured image 942 may be sets of pixels (e.g., pixel data). The electronic device 102 may obtain the captured image 942. In some configurations, the captured image 942 may be normalized, cropped and/or scaled by the electronic device 102 such that an object in the captured image 942 is approximately the size of objects represented in the composite search space 938.

The electronic device 102 (e.g., processor 112, image obtainer 114 and/or composite search space obtainer 118) may determine 944 a set of patches for the captured image 942. For example, the electronic device 102 may determine a plurality of subsets for the captured image 942. In the example given in FIG. 9, 4 patches are determined 944 for the captured image 942.

The electronic device 102 may determine a feature set 946 corresponding to each of the patches. Each feature set 946 may be a representation of an object (e.g., of a subset of an image of the object). In the example given in FIG. 9, each feature set 946 is a binary feature vector (e.g., a byte). It should be noted that the feature set 946 may include 8 bits or a different number of bits.

The electronic device 102 may match 948 (e.g., compare, score, etc.) the feature sets 946 to the composite search space 938 sets of feature sets. This may be accomplished as described herein. For example, the electronic device 102 (e.g., dedicated engine 128) may determine (e.g., calculate, compute, etc.) one or more metrics (e.g., SAD metrics, correlation metrics, etc.) that indicate a degree of similarity between the feature sets 946 of the captured image 942 and the feature sets of the composite search space 938. As illustrated in FIG. 9, the electronic device 102 (e.g., dedicated engine 128 and/or processor 112) may combine the metrics from each of the sets of feature sets to produce scores 950. Based on the scores 950, the electronic device 102 (e.g., dedicated engine 128 and/or processor 112) may determine a region of the composite search space 938 that is a matching region (e.g., that best matches the feature sets 946 and/or the captured image 942). The electronic device 102 (e.g., processor 112) may determine an identifier corresponding to the matching region.

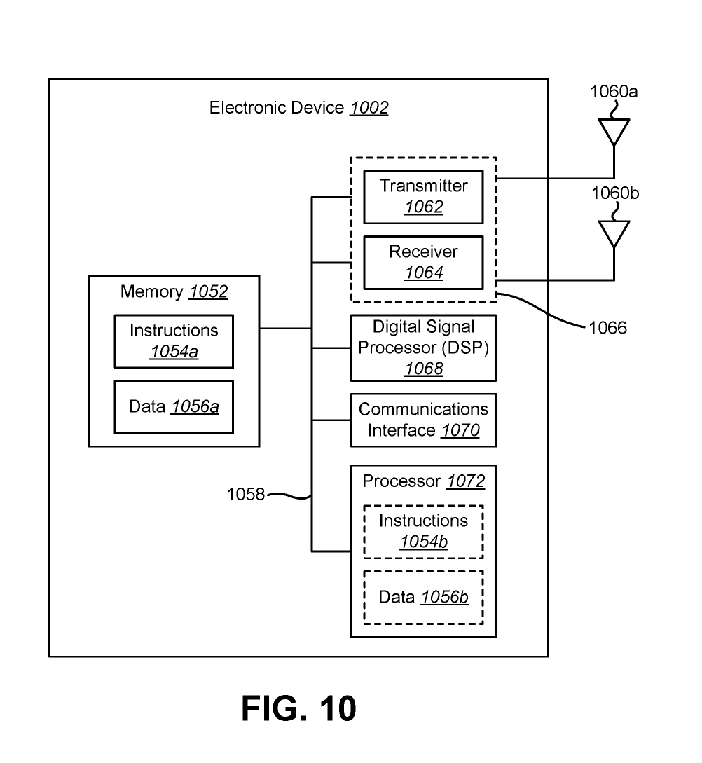

FIG. 10 illustrates certain components that may be included within an electronic device 1002 configured to implement various configurations of the systems and methods disclosed herein. The electronic device 1002 may be an access terminal, a mobile station, a user equipment (UE), a smartphone, a digital camera, a video camera, a tablet device, a laptop computer, etc. The electronic device 1002 may be implemented in accordance with one or more of the electronic devices 102, 702 described herein. The electronic device 1002 may be implemented to perform one or more of the functions, procedures, methods, steps, etc., described in connection with one or more of FIGS. 1-15.

The electronic device 1002 includes a processor 1072. The processor 1072 may be a general purpose single- or multi-chip microprocessor (e.g., an ARM), a special purpose microprocessor (e.g., a digital signal processor (DSP)), a microcontroller, a programmable gate array, etc. The processor 1072 may be referred to as a central processing unit (CPU). Although just a single processor 1072 is shown in the electronic device 1002, in an alternative configuration, a combination of processors (e.g., an ARM and DSP) could be implemented.

The electronic device 1002 also includes memory 1052. The memory 1052 may be any electronic component capable of storing electronic information. The memory 1052 may be embodied as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 1056a and instructions 1054a may be stored in the memory 1052. The instructions 1054a may be executable by the processor 1072 to implement one or more of the methods described herein. Executing the instructions 1054a may involve the use of the data 1056a that is stored in the memory 1052. When the processor 1072 executes the instructions 1054, various portions of the instructions 1054b may be loaded onto the processor 1072 and/or various pieces of data 1056b may be loaded onto the processor 1072.

The electronic device 1002 may also include a transmitter 1062 and a receiver 1064 to allow transmission and reception of signals to and from the electronic device 1002. The transmitter 1062 and receiver 1064 may be collectively referred to as a transceiver 1066. One or more antennas 1060a-b may be electrically coupled to the transceiver 1066. The electronic device 1002 may also include (not shown) multiple transmitters, multiple receivers, multiple transceivers and/or additional antennas.

The electronic device 1002 may include a digital signal processor (DSP) 1068. The electronic device 1002 may also include a communications interface 1070. The communications interface 1070 may allow and/or enable one or more kinds of input and/or output. For example, the communications interface 1070 may include one or more ports and/or communication devices for linking other devices to the electronic device 1002. In some configurations, the communications interface 1070 may include the transmitter 1062, the receiver 1064, or both (e.g., the transceiver 1066). Additionally or alternatively, the communications interface 1070 may include one or more other interfaces (e.g., touchscreen, keypad, keyboard, microphone, camera, etc.). For example, the communication interface 1070 may enable a user to interact with the electronic device 1002.

The various components of the electronic device 1002 may be coupled together by one or more buses, which may include a power bus, a control signal bus, a status signal bus, a data bus, etc. For the sake of clarity, the various buses are illustrated in FIG. 10 as a bus system 1058.

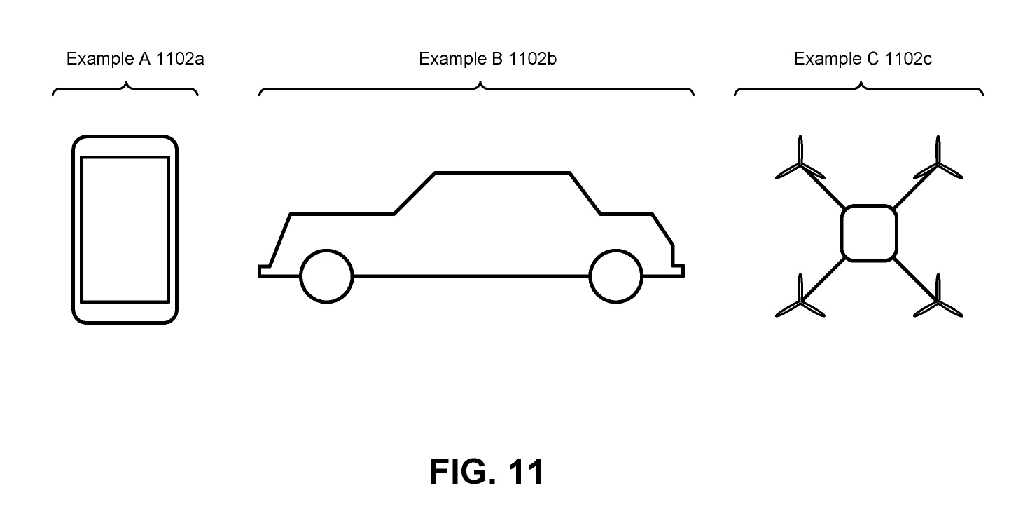

FIG. 11 illustrates examples 1102a-c of electronic devices in which systems and methods for recognizing an object in an image may be implemented. Example A 1102a is a wireless communication device (e.g., smartphone, tablet device, etc.). Example B 1102b is a vehicle (e.g., an automobile). Example C is an unmanned aerial vehicle (e.g., UAV, drone, etc.).

One or more of the electronic devices 102, 702, 1002 described herein may be implemented as (or included within) example A 1102a, example B 1102b and/or example C 1102c. Additionally or alternatively, one or more of the methods 200, 300, 800, operations, procedures, functions and/or steps described herein may be performed by one or more of example A 1102a, example B 1102b and/or example C 1102c. Additionally or alternatively, one or more of the components and/or elements described herein may be implemented in one or more of example A 1102a, example B 1102b and/or example C 1102c.

For instance, example A 1102a (e.g., a smartphone) may perform one or more of the operations described above, such as recognizing a person in a contacts list and presenting the person's name on the screen. In another instance, example B 1102b (an automobile) may recognize street signs and notify a driver and/or control the vehicle. In another instance, example C 1102c (a UAV) may capture video when people are recognized. Many other examples may be implemented in accordance with the systems and methods disclosed herein. For instance, the systems and method disclosed herein could be implemented in a robot that performs one or more actions (e.g., fetching something, assembling something, searching for an item, etc.) based on one or more recognized objects.

FIG. 12 is a functional block diagram illustrating an example of recognizing an object in an image in accordance with some configurations of the systems and methods disclosed herein. The functions, procedures, steps and/or blocks described in connection with FIG. 12 may be implemented in one or more of the electronic devices 102, 702 described in connection with FIGS. 1 and 7. FIG. 12 illustrates examples of input images 1274 (e.g., an input image for search space enrollment 1282 and an input image for query 1284), pre-processing 1276, face and eye detection 1278, face alignment 1280, feature extraction 1286, a search space feature set 1288, a query feature set 1290 and matching 1292. One or more of the functions, procedures, steps and/or blocks may be optional.

Search space enrollment 1282 may include one or more procedures for adding an object to a composite search space (e.g., for obtaining and/or adding to a composite search space). An input image 1274 for search space enrollment 1282 may be referred to as a gallery image. Query 1284 may include one or more procedures for determining whether an object in an image is recognized. An input image 1274 for query 1284 may be referred to as a probe image. It should be noted that search space enrollment 1282 and query 1284 may occur at different times. For example, search space enrollment 1282 may be performed before runtime (e.g., before attempting to recognize an object) in some configurations. The electronic device 102 may obtain one or more input images 1274 for search space enrollment 1282 and/or for query 1284.

The electronic device 102 may pre-process 1276 the input image(s) 1274. For example, the electronic device 102 may adjust the contrast and/or brightness of the image(s).

The electronic device 102 may perform face and eye detection 1278 on the image(s). For example, the electronic device 102 may locate the face and eyes of a person in the input image 1274. The face locations and eye locations of the images are illustrated with boxes and dots in FIG. 12.

The electronic device 102 may perform face alignment 1280 on the image(s). For example, the electronic device 102 may crop, rotate and/or scale the face of the person in order to align the face to a window.

The electronic device 102 may perform feature extraction 1286 on the aligned face(s). Performing feature extraction 1286 may include patch extraction. For example, the electronic device 102 may extract one or more patches (e.g., image subset(s), set(s) of pixels, etc.). For instance, the electronic device 102 may perform local patch extraction from the face geometry (e.g., aligned face). A patch from the probe image may be one example of the test patch described herein.

The electronic device 102 may extract one or more features (e.g., one or more feature sets) based on the one or more patches. For example, the electronic device 102 may generate one or more invariant and/or orthogonal patch representations based on the patches. Performing feature extraction on the aligned face(s) may produce a search space feature set 1288 and/or a query feature set 1290.

The electronic device 102 may perform matching 1292 based on the search space feature set 1288 and the query feature set 1290. For example, the electronic device 102 may determine a matching score 1294 based on the search space feature set 1288 and the query feature set 1290.

It should be noted that while FIGS. 12-15 and other examples herein may be described in terms of facial recognition, one or more of the functions, procedures, steps and/or blocks may be applied to a variety of objects. For example, the systems and methods disclosed herein may be applied for optical character recognition (with patches and/or feature sets corresponding to components of characters such as corners, lines, curves, intersections, etc., for instance), recognizing products (with patches and/or feature sets corresponding to components of products such as packaging shapes, labeling, etc., for instance), recognizing biometrics (e.g., faces, retinas, fingerprints, etc.), recognizing scenes (e.g., landscapes, buildings, etc.), recognizing vehicles, etc.

FIG. 13 is a diagram illustrating an example of an approach for feature extraction. For instance, FIG. 13 provides more detail on extracting features for a gallery image as described in connection with FIG. 12. One or more of the functions, procedures and/or steps described in connection with FIG. 13 may be performed by an electronic device 102. An appearance based approach may be suitable for real world applications. For example, explicit face geometry may not as useful, since faces have very similar structural information.

As illustrated in FIG. 13, the electronic device 102 may obtain an input image 1374 (e.g., a gallery image for creating and/or adding to a composite search space). The electronic device 102 may perform face and eye detection 1378 based on the input image 1374. In FIG. 13, the box illustrates the face detection (e.g., a bounding box from face detection), while the dots illustrate eye locations from eye detection.

The electronic device 102 may perform face alignment 1380. For example, the electronic device 102 may crop, rotate and/or scale the face of the person in order to align the face to a window.

The electronic device 102 may perform patch extraction 1396 based on the aligned face. The patch extraction 1396 may result in a set of patches 1398. Each of the patches 1398 may correspond to a component and/or location of the face. For example, the electronic device 102 may extract pre-defined local patches from the aligned face. In this approach, facial geometry is implicitly coupled with appearance information. In some configurations, each of the patches 1398 may have particular dimensions (e.g., 16×16 pixels), where the patches 1398 from a gallery image (for the composite search space, for example) may be the same size as or a different size from patches from a probe image (for query, for example).

The electronic device 102 may create a superset of sub templates by rescaling the face. It should be noted that some features (e.g., eyes, eyebrows, nose, upper face, etc.) may be more important (e.g., more useful in performing facial recognition) than others.

The electronic device 102 may determine one or more feature sets based on the patches 1398. In some configurations, the electronic device 102 may determine one or more feature sets by spatially filtering the patches 1398. For example, the electronic device 102 may perform illumination invariant feature encoding through spatial filtering. Edges may be one of the best ways to achieve illumination invariance. It should be noted that the face region may have rich horizontal (e.g., mouth, eye region, etc.) edge information, vertical (e.g., eye, nose bridge, etc.) edge information and diagonal (e.g., eye and nose bridge, etc.) edge information.

FIG. 14 is a diagram illustrating examples of a query feature set 1401 and a search space feature set 1403. As illustrated in FIG. 14, a query feature set 1401 may be extracted from an aligned face 1407 (from a gallery image, for example) and a search space feature set 1403 may be extracted from an aligned face 1407 (from a probe image, for example). It should be noted that while the query feature set 1401 and search space feature set 1403 are illustrated on one aligned face 1407 to show a correspondence in location, the query feature set 1401 may be based on a probe image, while the search space feature set 1403 may be based on a gallery image (that is different from the probe image, for instance).

A query feature set 1401 may be extracted from a probe image. In some configurations, the individual local feature locations for the probe image may have the same locations (e.g., same center locations) as locations for the gallery image. Alternatively, the individual feature locations may be different between probe and gallery images.

In some configurations, query feature set 1401 dimensions (e.g., 24×24) may be larger than search space feature set 1403 dimensions (e.g., 16×16). This may allow for an extra search region around the search space feature set 1403. As illustrated, this may result in extra region A 1405a and extra region B 1405b. Having different dimensions may accommodate a local shift to achieve improved matching. This local shifting may help to ensure that object recognition (e.g., face recognition) is robust against pose and landmark errors. The local shifting may be similar to block matching, where a neighborhood around the present region of interest is searched to get a minimum error. It should be noted that in other configurations, the query feature set 1401 and the search space feature set 1403 may have the same dimensions.

FIG. 15 is a diagram illustrating an example of matching between a representation of an object from a captured image with representations of objects in a composite search space. In particular, FIG. 15 illustrates an example of a query feature set 1501 (from a probe image, for example) and a search space feature set 1503 (from a gallery image, for example). In this example, the query feature set 1501 has larger dimensions than the search space feature set 1503. For instance, the search space feature set 1503 may have a height H and a width W, while the query feature set 1501 may have a height H+Δ₃+Δ₄ and a width W+Δ₁+Δ₂.

In some configurations, the electronic device 102 may perform matching (using a dedicated engine 128 such as a motion search engine, for example) in accordance with the approach described in connection with FIG. 15. Additionally or alternatively, the method 200 described in connection with FIG. 2 may performing matching 206 in accordance with the approach described in connection with FIG. 15.

The composite search space 1538 may include sets of search space feature sets 1503. For example, the composite search space 1538 may include groups of search space feature sets 1503. The composite search space 1538 described in connection with FIG. 15 may be an example of one or more of the composite search spaces 116, 438, 538, 638, 716, 938 described herein.

In some configurations of the systems and methods disclosed herein, extracted local feature regions may be matched independently. Matching may include two or more steps. For example, probe scale selection may be performed (e.g., performed first) using a subset of object features (e.g., facial features). All of the query feature sets 1501 (from the selected probe image, for example) may be evaluated (e.g., evaluated second) to get the final match score (e.g., a combined score, a combination of patch scores, etc.).

In some configurations, individual feature matching may be similar to block matching (e.g., a block matching algorithm (BMA)) with a minimum of SAD as matching criteria. For example, the electronic device 102 (e.g., dedicated engine 128) may perform matching in accordance with Equation (1) in some configurations.

$$S A D ( x , y ) = \frac{1}{{N}^{2}} {\sum }_{i = 0}^{N - 1} {\sum }_{j = 0}^{N - 1} \vert {G}_{ij} - {P}_{ij} \vert \qquad ( 1 )$$

In Equation (1), SAD(x, y) is a sum of absolute differences matching score (over horizontal dimension x and vertical dimension y), N is a matching range size, G is a search space feature set (from a gallery image, for example) and P is a query feature set (from a probe image, for example). It should be noted that in Equation (1), the matching range size may be the same in horizontal and vertical dimensions. In other approaches, the matching ranges may be different in horizontal and vertical dimensions.

In some configurations, the matching score for a patch (e.g., patchScore) may be determined as the minimum SAD score in accordance with Equation (2).

$$patchScore = arg {min}_{( x , y ) ∈ S} S A D ( x , y ) \qquad ( 2 )$$

In Equation (2), S is the valid search space (e.g., the part of the composite search space corresponding to a patch). Although this example is given in terms of SAD, other measures for matching may be utilized.

In some configurations, the combined matching score (e.g., the matching score for a whole image, such as an aligned face) may be determined by combining the patch scores. This may be accomplished in accordance with Equation (3) in some approaches.

$$MatchScore = {\sum }_{i = 0}^{p ( 31 )} {patchScore}_{i} \qquad ( 3 )$$

As illustrated in Equation (3), the patch scores for all 31 patches p (or a different number of patches in other configurations) may be summed in order to produce the combined score (e.g., MatchScore). In some configurations, the patch scores may be weighted. For example, patch scores corresponding to more important object components (e.g., more distinctive object features, more distinction facial features, etc.) may be given more weight. The combined scores corresponding to each of the regions (corresponding to gallery images, for example) may be compared to determine the best matching region (e.g., a gallery image with a corresponding lowest MatchScore).

In some approaches, hierarchical (with two or more steps, for instance) block searching (e.g., BMA) may be employed for search acceleration. For example, sparse searching of the composite search space 1538 (e.g., gallery) in query feature set 1501 (e.g., probe region) may be performed first. As illustrated in FIG. 15, the first hierarchical level 1509 (e.g., the locations in the composite search space 1538 at the first hierarchical level 1509) may be searched first. The best matching location at the first hierarchical level 1511 may be determined. More detailed (e.g., higher level, higher resolution, exhaustive, etc.) searching around the best matching location at the first level (in the query feature set, probe, etc., from the first pass) may be performed second. For example, the second hierarchical level 1513 of the composite search space may be searched around the best match at the first level 1511. Matching scores from individual face features may be combined (e.g., fused) with weights to determine the combined scores. The best (e.g., lowest) score at the second hierarchical level may indicate the best matching region (e.g., best matching search space feature set 1503). The best matching region (e.g., location) may correspond to an identifier.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio and microwave, then the coaxial cable, fiber optic cable, twisted pair, DSL, or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device.

It is to be understood that the claims are not limited to the precise configuration and components illustrated above. Various modifications, changes and variations may be made in the arrangement, operation and details of the systems, methods and apparatus described herein without departing from the scope of the claims.

What is claimed is:

1. An electronic device, comprising:
a memory configured to store a composite search space comprising a plurality of adjacent cells, wherein each of the adjacent cells comprises a representation of an object; and
a dedicated engine configured to match a representation of an object from a captured image with the representations of the objects in the composite search space.

2. The electronic device of claim 1, wherein the dedicated engine is a motion search engine.

3. The electronic device of claim 1, further comprising dedicated video encoder hardware that comprises the dedicated engine.

4. The electronic device of claim 1, wherein each of the representations of the composite search space comprises a patch of an image.

5. The electronic device of claim 1, wherein each of the representations of the composite search space comprises a feature set.

6. The electronic device of claim 5, wherein the feature sets are arranged to fit macroblock boundaries with a motion search engine.

7. The electronic device of claim 1, wherein the composite search space comprises sets of feature sets.

8. The electronic device of claim 1, wherein the dedicated engine is configured to calculate a sum of absolute differences (SADs) for each of a plurality of feature sets in the composite search space.

9. The electronic device of claim 1, further comprising a processor configured to:
obtain a plurality of images;
determine a set of patches for each of the plurality of images;
determine a feature set for each of the patches; and
produce the composite search space based on the feature sets.

10. The electronic device of claim 1, further comprising a camera configured to obtain the captured image.

11. A method performed by an electronic device, the method comprising:
obtaining a composite search space comprising a plurality of adjacent cells, wherein each of the adjacent cells comprises a representation of an object; and
matching, by a dedicated engine, a representation of an object from a captured image with the representations of the objects in the composite search space.

12. The method of claim 11, wherein the dedicated engine is a motion search engine.

13. The method of claim 11, wherein the electronic device comprises dedicated video encoder hardware that comprises the dedicated engine.

14. The method of claim 11, wherein each of the representations of the composite search space comprises a patch of an image.

15. The method of claim 11, wherein each of the representations of the composite search space comprises a feature set.

16. The method of claim 15, wherein the feature sets are arranged to fit macroblock boundaries with a motion search engine.

17. The method of claim 11, wherein the composite search space comprises sets of feature sets.

18. The method of claim 11, wherein the matching comprises calculating a sum of absolute differences (SADs) for each of a plurality of feature sets in the composite search space.

19. The method of claim 11, further comprising:
obtaining a plurality of images;
determining a set of patches for each of the plurality of images;
determining a feature set for each of the patches; and
producing the composite search space based on the feature sets.

20. The method of claim 11, further comprising capturing the captured image with a camera.

21. An apparatus, comprising:
means for obtaining a composite search space comprising a plurality of adjacent cells, wherein each of the adjacent cells comprises a representation of an object; and
dedicated engine means for matching a representation of an object from a captured image with the representations of the objects in the composite search space.

22. The apparatus of claim 21, wherein the dedicated engine means is a motion search engine.

23. The apparatus of claim 21, wherein each of the representations of the composite search space comprises a patch of an image.

24. The apparatus of claim 21, wherein each of the representations of the composite search space comprises a feature set.

25. The apparatus of claim 21, further comprising:
means for obtaining a plurality of images;
means for determining a set of patches for each of the plurality of images;
means for determining a feature set for each of the patches; and
means for producing the composite search space based on the feature sets.

26. A computer-program product, comprising a non-transitory computer-readable medium having instructions thereon, the instructions comprising:
code for causing an electronic device to obtain a composite search space comprising a plurality of adjacent cells, wherein each of the adjacent cells comprises a representation of an object; and
code for causing the electronic device to match, by a dedicated engine, a representation of an object from a captured image with the representations of the objects in the composite search space.

27. The computer-program product of claim 26, wherein the dedicated engine is a motion search engine.

28. The computer-program product of claim 26, wherein each of the representations of the composite search space comprises a patch of an image.

29. The computer-program product of claim 26, wherein each of the representations of the composite search space comprises a feature set.

30. The computer-program product of claim 26, further comprising:
code for causing the electronic device to obtain a plurality of images;
code for causing the electronic device to determine a set of patches for each of the plurality of images;
code for causing the electronic device to determine a feature set for each of the patches; and
code for causing the electronic device to produce the composite search space based on the feature sets.
